(19) United States
(12) Patent Application Publication
(10) Pub. No.: US 2011/0028225 A1
(43) Pub. Date: Feb. 3, 2011

(54) SLIP CLUTCH

(75) Inventors: Jonathan JAMESON, Dalton, OH (US); Scott SCHRADER, Canton, OH (US)

Correspondence Address: Simpson & Simpson, PLLC, 5555 Main Street, Williamsville, NY, 14221, US

(73) Assignee: SCHAEFFLER TECHNOLOGIES GMBH & CO. KG, Herzogenaurach (DE)

(21) Appl. No.: 12/844,437

(22) Filed: Jul. 27, 2010

Related U.S. Application Data
(60) Provisional application No. 61/229,076, filed on Jul. 28, 2009.

(51) Int. Cl. F16D 43/20

(52) U.S. Cl. 464/30

(57) ABSTRACT

A reactor plate connected to a flywheel; a resilient element connected to a plate for a damper assembly; and first and second friction elements. The resilient element urges the first and second friction elements into engagement with the flywheel and the reactor plate, respectively, to rotationally lock the resilient element, the flywheel, and the plate for a torque on the flywheel less than a first value. In one embodiment, at least one of the first or second friction elements is fixedly secured to the reactor plate or the flywheel, respectively. In one embodiment, at least one of the first or second friction elements is fixedly secured to the resilient element.

### CROSS-REFERENCE TO RELATED APPLICATIONS

This application claims the benefit under 35 U.S.C.§119(e) of U.S. Provisional Application No. 61/229,076, filed Jul. 28, 2009.

### FIELD OF THE INVENTION

The invention relates to a slip clutch, in particular, to a slip clutch with a reduced parts count.

### BACKGROUND OF THE INVENTION

The prior art teaches the use of a diaphragm spring, a reactor plate, multiple drive plates, and multiple friction plates to form a slip clutch.

### BRIEF SUMMARY OF THE INVENTION

The present invention broadly comprises a slip clutch, including: a reactor plate connected to a flywheel; a resilient element connected to a plate for a damper assembly; and first and second friction elements. The resilient element urges the first and second friction elements into engagement with the flywheel and the reactor plate, respectively, to rotationally lock the resilient element, the flywheel, and the plate for a torque on the flywheel less than a first value. In one embodiment, at least one of the first or second friction elements is fixedly secured to the reactor plate or the flywheel, respectively. In one embodiment, at least one of the first or second friction elements is fixedly secured to the resilient element.

In one embodiment, the resilient element provides a torque flow path between the flywheel and the damper assembly. In one embodiment, for a rotational torque load on the flywheel greater than a first level, the resilient element rotates with respect to the flywheel or the plate. In one embodiment, the resilient element includes a diaphragm spring.

The present invention also broadly comprises a slip clutch, including: a reactor plate connected to a flywheel; and a resilient element connected to a plate for a damper assembly and including first and second friction elements. The resilient element urges the first and second friction elements into engagement with the flywheel and the reactor plate, respectively, to rotationally lock the resilient element, the flywheel, and the plate for a torque on the flywheel less than a first value. In one embodiment, for a rotational torque load on the flywheel greater than a first level, the resilient element rotates with respect to the flywheel or the plate. In one embodiment, the resilient element includes a diaphragm spring.

It is a general object of the present invention to provide a slip clutch with a minimum number of parts.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application; and,

FIG. 2 is a partial cross-sectional view of a present invention slip clutch.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

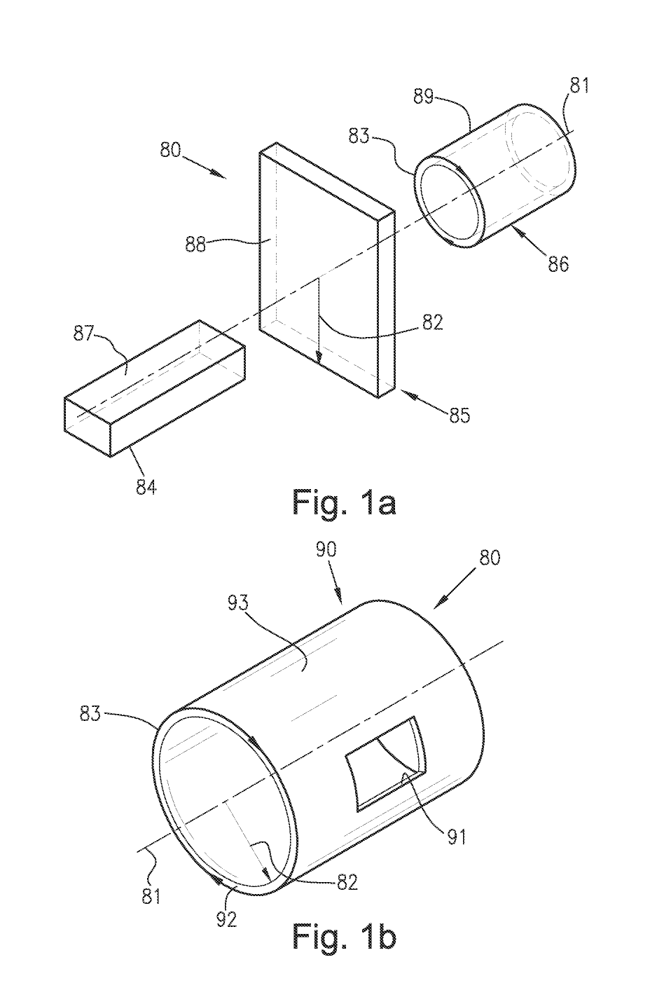

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

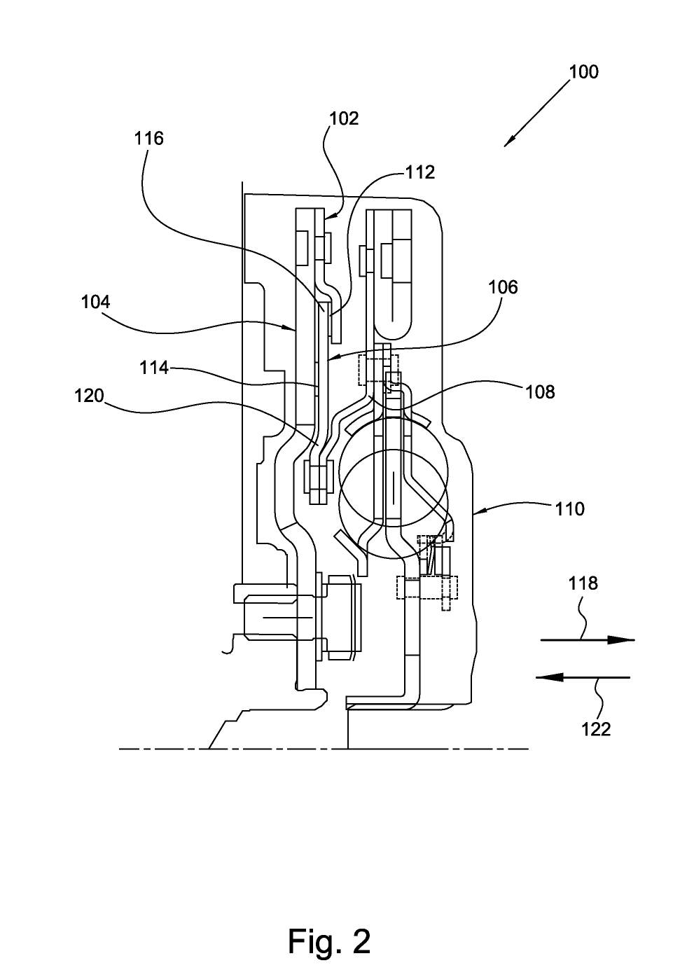

FIG. 2 is a front view of present invention slip clutch 100, including reactor plate 102 connected to flywheel 104, resilient element 106 connected to plate 108 for damper assembly 110, and friction elements 112 and 114. The resilient element urges the friction elements into engagement with the flywheel and the reactor plate to rotationally lock the resilient element, the flywheel, and the plate for a torque on the flywheel less than a certain value. For example, the resilient element is biased such that end 116 displaces in direction 118 and end 120 displaces in direction 122, pressing the friction elements against the reactor plate and the flywheel to close the clutch, that is, to form a torque-transmitting path from the flywheel through the clutch to the damper assembly as the flywheel rotates.

However, the bias of the resilient element is able to maintain the rotational locking of the friction elements and the reactor plate and flywheel only up to the certain torque load on the flywheel. For example, as the torque load on the flywheel increases beyond this level, the forces exerted by the flywheel on the clutch exceed the force applied by the resilient element and the flywheel and the resilient element begin to rotate independently, that is, the clutch slips. By enabling the clutch to slip for torque values greater than the certain value, the clutch prevents undesirably large torque levels, for example, spikes in torque levels, to be transferred between the flywheel and the damper element.

The resilient element can be any resilient element known in the art. In one embodiment, the element is a diaphragm spring. In one embodiment, one or both of the friction elements are separate friction rings. For example, a ring is separately formed from the reactor plate, flywheel, or resilient element and is not fixedly secured to the reactor plate, flywheel, or resilient element. In one embodiment, one or both of the friction elements are fixedly secured to the reactor plate. In one embodiment, one or both of the friction elements are fixedly secured to the flywheel, or the resilient element. It should be understood that any combination of the configurations described supra is possible. For example, one friction element can be a separate/non-fixedly secured ring and the other friction element can be fixedly secured to one of the resilient element, the flywheel, or the reactor plate; one friction element can be fixedly secured to the reactor plate and the other friction element can be fixedly secured to the flywheel; or both frictional elements can be fixedly secured to the resilient element.

Advantageously, clutch 100 reduces the number of parts taught supra for a slip clutch. For example, a resilient element, such as a diaphragm spring, and multiple clutch plates are combined into a single component, for example, resilient element 106. For example, the axial thickness of resilient element 106 replaces the combined thickness of the diaphragm spring and multiple clutch plates described supra. Thus, the axial space requirements, parts count, and overall complexity are dramatically reduced for clutch 100.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A slip clutch, comprising:
a reactor plate connected to a flywheel;
a resilient element connected to a plate for a damper assembly; and,
first and second friction elements, wherein the resilient element urges the first and second friction elements into engagement with the flywheel and the reactor plate, respectively, to rotationally lock the resilient element, the flywheel, and the plate for a torque on the flywheel less than a first value.

2. The slip clutch of claim 1 wherein at least one of the first or second friction elements is fixedly secured to the reactor plate or the flywheel, respectively.

3. The slip clutch of claim 1 wherein at least one of the first or second friction elements is fixedly secured to the resilient element.

4. The slip clutch of claim 1 wherein the resilient element provides a torque flow path between the flywheel and the damper assembly.

5. The slip clutch of claim 1 wherein for a rotational torque load on the flywheel greater than a first level, the resilient element rotates with respect to the flywheel or the plate.

6. The slip clutch of claim 1 wherein the resilient element includes a diaphragm spring.

7. A slip clutch, comprising:
a reactor plate connected to a flywheel; and,
a resilient element connected to a plate for a damper assembly and including first and second friction elements, wherein the resilient element urges the first and second friction elements into engagement with the flywheel and the reactor plate, respectively, to rotationally lock the resilient element, the flywheel, and the plate for a torque on the flywheel less than a first value.

8. The slip clutch of claim 7 wherein for a rotational torque load on the flywheel greater than a first level, the resilient element rotates with respect to the flywheel or the reactor plate.

9. The slip clutch of claim 7 wherein the resilient element includes a diaphragm spring.
